(19) United States
(12) Patent Application Publication
(10) Pub. No.: US 2026/0310064 A1
(43) Pub. Date: Oct. 8, 2026

(54) KERNEL FUNCTION GENERATION METHOD, OPTICAL PROXIMITY CORRECTION METHOD USING THE KERNEL FUNCTION, AND MASK MANUFACTURING METHOD INCLUDING THE OPTICAL PROXIMITY CORRECTION METHOD

(71) Applicant: Samsung Electronics Co., Ltd., Suwon-si (KR)

(72) Inventors: Ingyun Chung, Suwon-si (KR); Jinho Mun, Suwon-si (KR); Hyeonho Cho, Suwon-si (KR)

(21) Appl. No.: 19/410,497

(22) Filed: Dec. 5, 2025

(30) Foreign Application Priority Data
Apr. 7, 2025 (KR) 10-2025-0044936

(51) Int. Cl. G03F 1/36; G03F 1/70; G06F 30/398; G06F 119/18

(52) U.S. Cl. CPC G03F 1/36; G03F 1/70; G06F 30/398; G06F 2119/18

(57) ABSTRACT

A kernel function is generated for accurately predicting a critical dimension (CD) error in a unit block edge (UBE) region as well as in a center region. An optical proximity correction (OPC) method uses the kernel function. A mask manufacturing method includes the OPC method. The method of generating a kernel function includes inputting data of a cell layout according to a plurality of factors for a pattern, calculating a CD error of a pattern under conditions of the factors, generating individual kernel functions that simulate the impact of the factors on the CD error, and generating a combined kernel function by multiplying all of the individual kernel functions.

### CROSS-REFERENCE TO RELATED APPLICATION

This application is based on and claims priority under 35 U.S.C. § 119 to Korean Patent Application No. 10-2025-0044936, filed on Apr. 7, 2025, in the Korean Intellectual Property Office, the disclosure of which is incorporated by reference herein in its entirety.

### BACKGROUND

In a semiconductor process, a photolithography process using a mask may be performed to form a pattern on a semiconductor substrate such as a wafer. A mask may be regarded as a pattern transfer body including an opaque material pattern shape formed on a transparent base material. To manufacture the mask, first, a layout for the required pattern is designed, and then an optical proximity corrected layout data obtained through optical proximity correction (OPC) is transferred as mask tape-out (MTO) design data. Afterwards, mask data preparation (MDP) may be performed based on the MTO design data, and an exposure process, etc. may be performed on a mask substrate.

### SUMMARY

This disclosure relates to a method of manufacturing a mask, and more particularly, to an optical proximity correction (OPC) method by using a kernel function and a method of manufacturing a mask including the OPC method.

This disclosure provides a method of generating a kernel function for accurately predicting critical dimension (CD) error in a unit block edge (UBE) region as well as the center region, an optical proximity correction (OPC) method by using the kernel function, and a mask manufacturing method including the OPC method.

In addition, the objective to be solved by this disclosure is not limited to the above-described ones, and other objectives may be clearly understood by those skilled in the art from the description below.

According to an aspect of this disclosure, there is provided a method of generating a kernel function, the method including inputting data of a cell layout according to a plurality of factors for a pattern, calculating a CD error of the pattern under respective conditions of the factors, generating individual kernel functions that simulate an impact of the factors on the CD error, and generating a combined kernel function by multiplying all of the individual kernel functions.

According to another aspect of this disclosure, there is provided an OPC method including inputting data of a cell layout according to a plurality of factors for a pattern, calculating a CD error of the pattern under respective conditions of the factors, generating individual kernel functions that simulate an impact of the factors on the CD error, generating a combined kernel function by applying weights to the individual kernel functions and multiplying all of the individual kernel functions, generating an OPC model by using the combined kernel function, and performing a simulation by using the OPC model.

According to another aspect of this disclosure, there is provided a method of manufacturing a mask, the method including obtaining an OPC-ed layout by performing an OPC method using a kernel function, performing optical rule check (ORC) on the OPC-ed layout, transferring a final OPC-ed layout that has passed the ORC, as mask tape-out (MTO) design data, preparing mask data based on the MTO design data, and exposing a mask substrate based on the mask data, wherein the obtaining of the OPC-ed layout includes inputting data of a cell layout according to a plurality of factors for a pattern, calculating a CD error of the pattern under respective conditions of the factors, generating individual kernel functions that simulate an impact of the factors on the CD error, generating a combined kernel function by applying weights to the individual kernel functions and multiplying all of the individual kernel functions, generating an OPC model by using the combined kernel function, and performing a simulation by using the OPC model.

### BRIEF DESCRIPTION OF THE DRAWINGS

Implementations will be more clearly understood from the following detailed description taken in conjunction with the accompanying drawings in which:

FIG. 1 is a flowchart schematically showing a process of a kernel function generation method according to some implementations;

FIGS. 2A, 2B, 2C, 2D, and 2E are conceptual diagrams for describing splitting conditions of respective factors;

FIG. 3 is a flowchart showing in detail an operation of generating individual kernel functions in the kernel function generation method of FIG. 1;

FIGS. 4A, 4B, 4C, and 4D are graphs showing calculated values of critical dimension (CD) error according to a pitch, CNT bias, and BG bias, based on rigorous simulation;

FIGS. 5A, 5B, and 5C are graphs showing prediction results of CD error according to CNT bias under fixed conditions of a pitch and a BG bias, based on a dot product kernel function;

FIGS. 6A, 6B, and 6C are graphs showing prediction results of CD error according to a pitch under fixed conditions of a BG bias and a CNT bias, based on a dot product kernel function;

FIGS. 7A, 7B, and 7C are graphs showing prediction results of CD error according to a BG bias under fixed conditions of a pitch and a CNT bias, based on a rational quadratic kernel function;

FIGS. 8A and 8B are graphs conceptually illustrating a method of generating a combined kernel function;

FIGS. 9A, 9B, 9C, and 9D are graphs showing prediction results of CD error according to a pitch, a CNT bias, and a BG bias, based on a combined kernel function.

FIG. 10A is a flowchart schematically showing a process of a kernel function generation method according to some implementations;

FIG. 10B is a flowchart showing in detail an operation of generating a combined kernel function in the kernel function generation method of FIG. 10A;

FIGS. 11A and 11B are graphs showing prediction results of CD error in a unit block edge (UBE) according to a BG bias under non-learned conditions of a pitch and a CNT bias;

FIG. 12 is a flowchart schematically showing a process of an optical proximity correction (OPC) method by using a kernel function, according to some implementations; and

FIG. 13 is a flowchart schematically showing a process of a mask manufacturing method including an OPC method, according to some implementations.

### DETAILED DESCRIPTION

Hereinafter, implementations will be described more fully with reference to the accompanying drawings. In the drawings, like elements are labeled like reference numerals and repeated description thereof will be omitted.

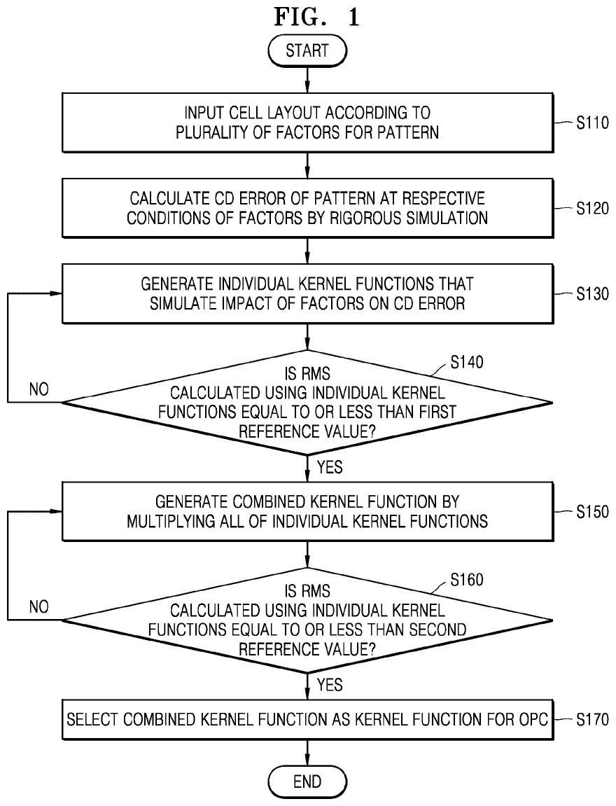

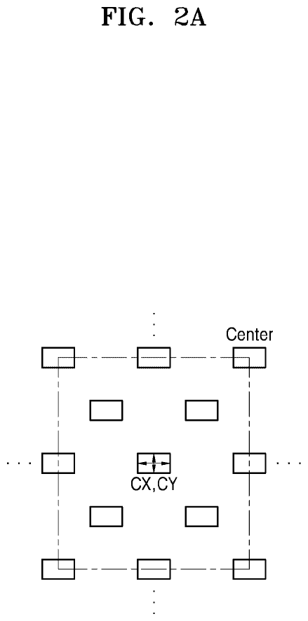

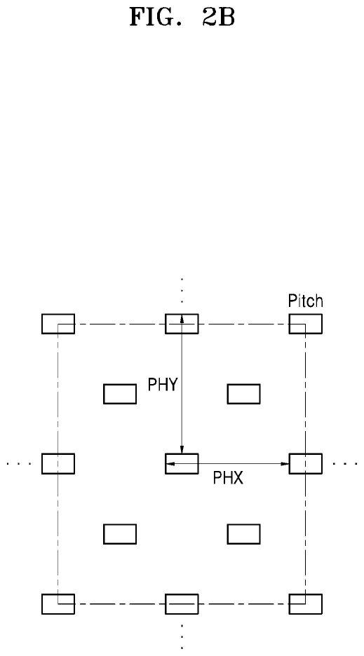

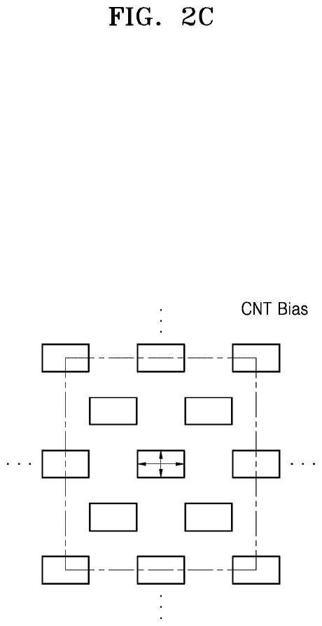

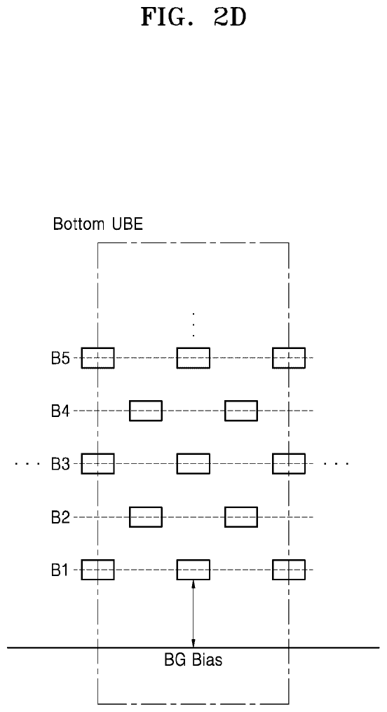

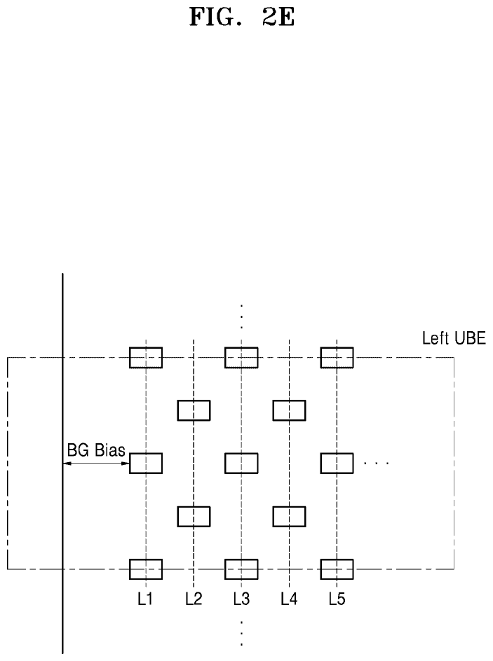

FIG. 1 is a flowchart schematically showing a process of a kernel function generation method according to some implementations, and FIGS. 2A, 2B, 2C, 2D, and 2E are conceptual diagrams for describing splitting conditions of respective factors.

Referring to FIGS. 1, 2A, 2B, 2C, 2D, and 2E, in the kernel function generation method of the present implementations, a cell layout according to a plurality of factors for a pattern is input (S110). Here, a cell layout may indicate a cell layout of a memory device such as, for example, dynamic random-access memory (DRAM). However, the cell layout is not limited to DRAM. The cell layout may include a block area in which memory cells are arranged and a peripheral area in which peripheral circuits are arranged. Additionally, the block area may include a center area in the center of the block area and a Unit Block Edge (UBE) area at a block edge.

A plurality of factors for a pattern may indicate factors that affect a kernel function. For example, in the kernel function generation method of the present implementations, the plurality of factors for a pattern may include a pitch (PH) of the pattern, a bias for a size of the pattern, and a bias for a distance between the pattern and a block edge. Hereinafter, the pitch of the pattern is simply referred to as a ‘pitch’. Assuming that the pattern is a contact (CNT), a bias for the size of the pattern is referred to as a ‘CNT bias’ below. Additionally, a bias for the distance between the pattern and the block edge is referred to as a ‘BG bias’ below. For reference, BG is an abbreviation for background, which may indicate the block edge described above. The factors are not limited to the pitch, CNT bias, and BG bias. For example, various factors may be introduced to generate an optimal and fast kernel function.

FIG. 2A shows the critical dimensions (CDs) CX, CY of the pattern in a center along an x-axis and a y-axis, and FIG. 2B shows pitches PHX, PHY in the x-axis and y-axis directions. FIG. 2C shows the concept of CNT bias, FIG. 2D shows the concept of BG bias of a bottom UBE, and FIG. 2E shows the concept of BG bias of a left UBE. A top UBE is symmetrical to the bottom UBE, and the left UBE is symmetrical to a right UBE, and thus concept of BG bias of the top UBE and the right UBE is not needed.

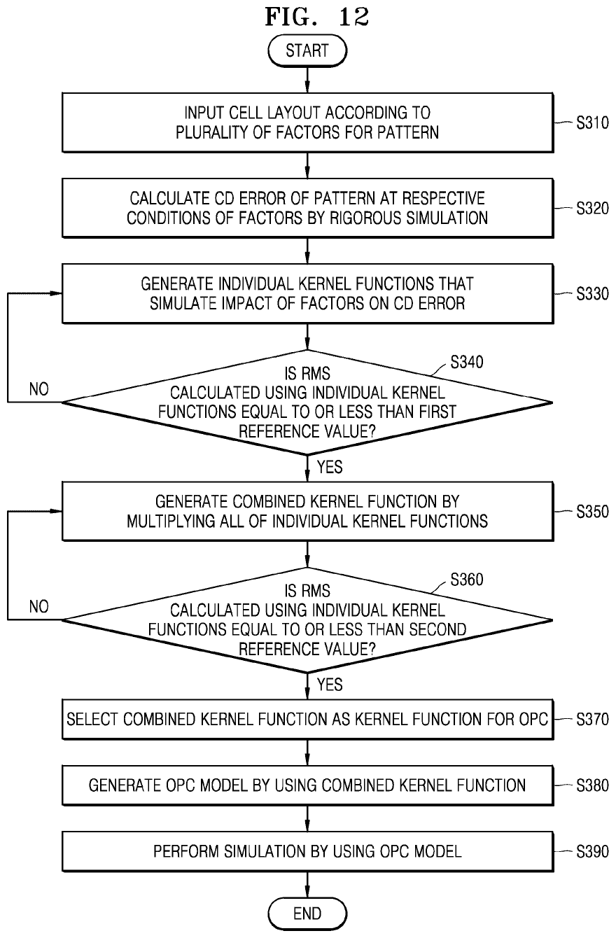

Here, a kernel function may indicate a function used for optical proximity correction (OPC) modeling in an OPC method. For example, in the OPC method, a simulation is performed using an OPC model, and a kernel function, which is a function expressing a transfer process of an exposure process, may be included in the OPC model. The OPC method is described in detail in the description with reference to FIG. 12.

After inputting a cell layout, a CD error of the pattern is calculated under the conditions of the respective factors through rigorous simulation (S120). Here, rigorous simulation may include, for example, simulation using the Finite-Different-Time-Domain (FDTD) algorithm. However, rigorous simulation is not limited to simulation using the FDTD algorithm.

Each of the factors may be split into a plurality of conditions, and the CD error relative to a target may be calculated through rigorous simulation for each condition. For example, in the kernel function generation method of the present implementations, pitch may be split into four types: A, B, C, and D (A<B<C<D). Additionally, CNT bias may be split into nine types: −2, −1.5, −1, −0.5, 0, 0.5, 1.0, 1.5, and 2.0. BG bias may be, in each of the bottom UBE and the left UBE, split into 56 types in 10 nm units from 0 nm to 550 nm. For individual analysis of an UBE pattern, as shown in FIG. 2D, the bottom UBE may be split into B1, B2, B3, B4, and B5 from an outermost pattern, and as shown in FIG. 2E, the left UBE may be split into L1, L2, L3, L4, and L5 from an outermost pattern. Accordingly, there are 22 types of CD errors: CX, CY, B1X, B2X, B3X, B4X, B5X, B1Y, B2Y, B3Y, B4Y, B5Y, L1X, L2X, L3X, L4X, L5X, L1Y, L2Y, L3Y, L4Y, and L5Y. Here, CX and CY may represent the CD errors of the x-axis and y-axis at the center. As a result, a dataset for each type of CD error may be 4*9*56=2016, with 4 types for pitch, 9 types for CNT bias, and 56 types for BG bias, and the total dataset for 22 types of CD errors may be 2016*22=44352. The types of splitting for each factor are not limited to the numbers stated above. Thus, the number of total datasets may also vary.

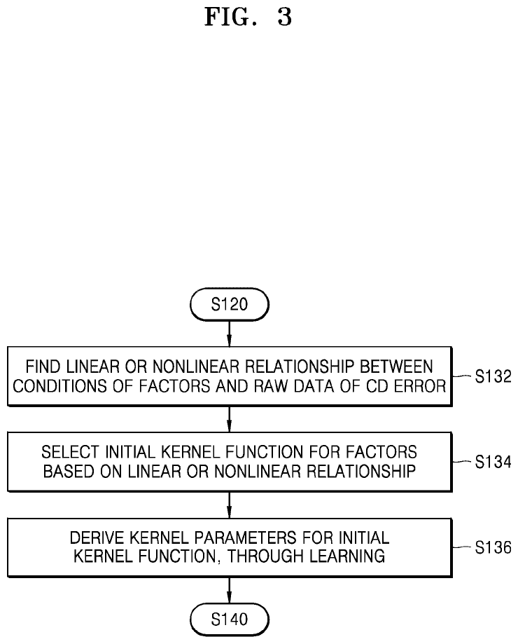

After calculating a CD error of the pattern under the conditions of the factors, individual kernel functions that simulate the impact of the factors on the CD error are generated (S130). In the generating of the individual kernel functions (S130), for example, a first kernel function for pitch may be generated, a second kernel function for CNT bias may be generated, and a third kernel function for BG bias may be generated. The respective individual kernel functions may be generated by learning by using a dataset of the conditions above. Here, learning may indicate, for example, machine learning (ML). Additionally, the individual kernel functions may be generated by selecting an appropriate initial kernel function based on a linear or nonlinear relationship and obtaining kernel parameters through learning. The method of generating individual kernel functions is described in detail with reference to FIGS. 3, 4A, 4B, 4C, 4D, 5A, 5B, 5C, 6A, 6B, 6C, 7A, 7B, and 7C.

After generating the individual kernel functions, whether a Root Mean Square (RMS) calculated using the individual kernel functions is less than or equal to a first reference value is determined (S140). Here, the RMS may indicate an RMS of a difference between a CD error of the dataset and a CD error predicted by the individual kernel functions. The first reference value may be, for example, 1.5 nm. However, the first reference value is not limited to the above value.

If the RMS exceeds the first reference value (No), the process returns to the generating of the individual kernel functions (S130), and individual kernel functions are generated again through learning using the dataset.

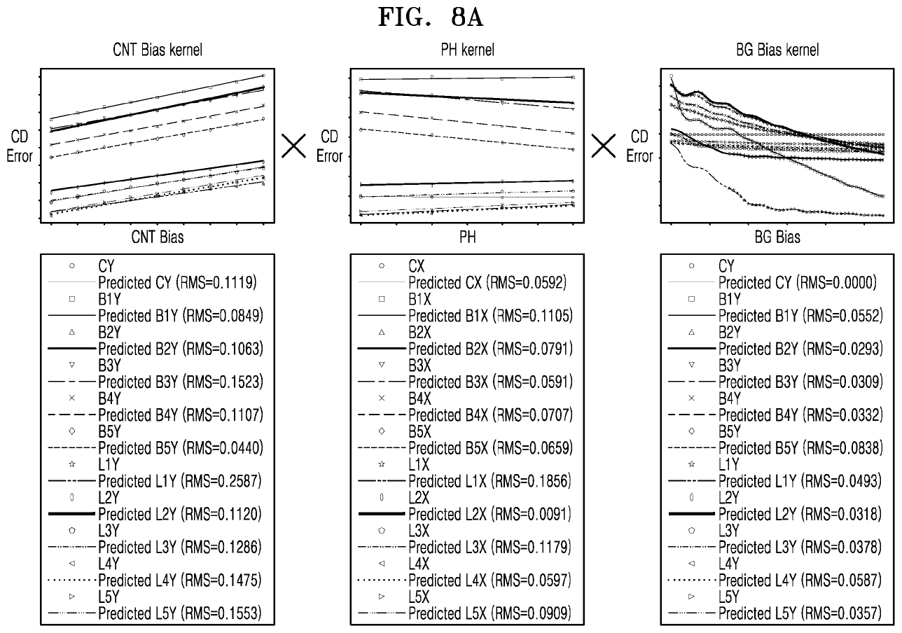

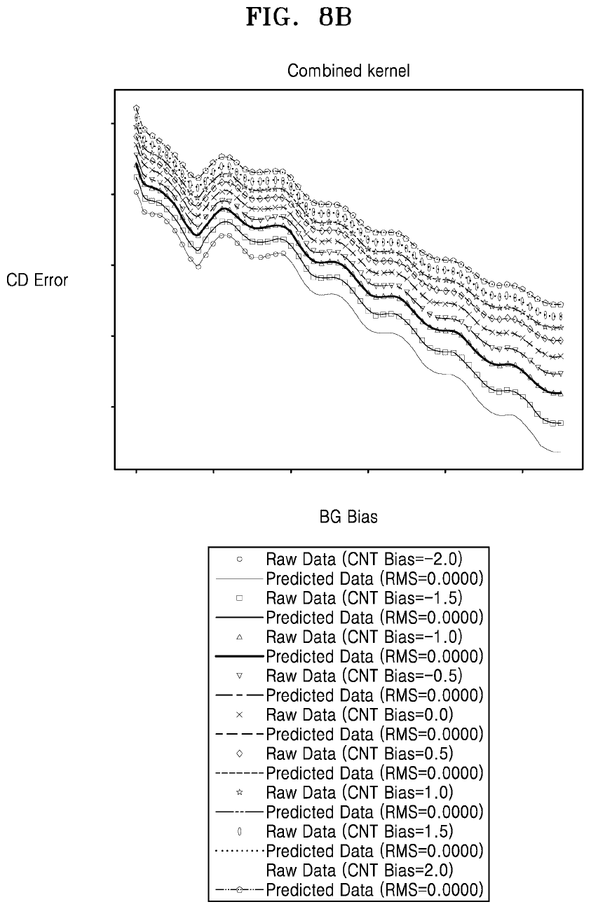

If the RMS is less than or equal to the first reference value (Yes), a combined kernel function is generated by multiplying all individual kernel functions (S150). Here, a product may correspond to a dot product. The combined kernel function is a kernel function for a plurality of factors, and thus may correspond to a multivariate kernel function. When obtaining the combined kernel function, different weights may be applied to the individual kernel functions. For example, a relatively high weight may be assigned to a kernel function related to a factor that has a relatively large impact on the CD error, and a relatively low weight may be assigned to a kernel function related to a factor that has a relatively small impact on the CD error. The method of generating a combined kernel function is described in detail in with reference to FIGS. 8A and 8B.

After generating the combined kernel function, whether an RMS calculated using the combined kernel function is less than or equal to a second reference value is determined (S160). Here, the RMS may indicate an RMS of a difference between the CD error of the dataset and a CD error predicted by the combined kernel function. The second reference value may be, for example, 1.0 nm. However, the second reference value is not limited to the above value.

If the RMS exceeds the second reference value (No), the process proceeds to the generating of the combined kernel function (S150), and the weights of the individual kernel functions are changed to generate a combined kernel function again.

If the RMS is less than or equal to the second reference value (Yes), the combined kernel function is selected as a kernel function for OPC (S170). The kernel function for OPC may refer to a kernel function used in the OPC model described above.

According to the kernel function generation method of the present implementations, an optimal kernel function may be generated in response to variations in pattern pitch, BG bias, and CNT bias, based on rigorous simulation, and furthermore, this kernel function generation methodology may be implemented as a tool through Python. According to the kernel function generation method of the present implementations, by quickly responding to the development of DRAM products that changes according to changes in pitch size called design node, optimal cell patterning on a wafer may be obtained, and also the cost of mask production may be reduced as additional mask production for OPC modeling according to the conditions of factors is unnecessary. In addition, by flexibly responding to cell patterns with various UBE environments, not open (NOP) defects in a UBE may be prevented in advance.

For reference, as the development of DRAM products has progressed at a rapid pace recently, reliability tests are being conducted in parallel for designs that have changes in pitch size and pattern shape applied. Thus, it may be important to respond to various patterns of pitch according to changes in a pitch size, an UBE environment, a contact pattern size, etc. Additionally, OPC modeling based on optimized ML kernel functions may be required to accurately pattern a wafer according to CD targeting. However, the current technology, where only the CD of contact patterns within the center area and the UBE area is measured based on a main cell block and then a kernel function is generated based on the calculated CD error, has limitations in quickly responding to recent DRAM development trends.

Current technology allows optimal patterning on a wafer for the measured main cell, but optimal patterning may be difficult for cell patterns where the pattern pitch becomes finer due to changes in pitch size or where the UBE environment changes. In addition, apart from the change in pitch size, there are cell patterns within DRAM products not only in a block area but also in a peripheral area, and the cell patterns within the peripheral area often have a UBE pattern shape that is completely different from that of the cell patterns within the block area.

For example, the BG bias, which refers to a distance between the outermost cell pattern of the UBE and a block edge or background, may be different for each left, right, top, and bottom location within the cell pattern, and may also be different depending on the coordinates of the cell patterns located within a chip (e.g., whether the location is a block area or a peripheral area). In the case of DRAM products which are currently mass-produced, there are cell patterns in which the BG bias between cell patterns differs by 100 nm or more. In such cases, it may be very difficult to accurately perform CD targeting of UBE through an OPC model based on the existing pattern of the main cell, as the UBE environment within the cell varies greatly. In particular, when a simulation is performed on a cell pattern of an UBE with a BG bias difference of 100 nm or more by using an OPC model based on an identical kernel function, the CD targeting may be significantly misaligned, which may cause an NOP defect in a UBE and significantly affect the product yield. However, according to the kernel function generation method of the present implementations, an optimal kernel function may be generated through the above-described method, and thus, all of the above-described problems may be addressed.

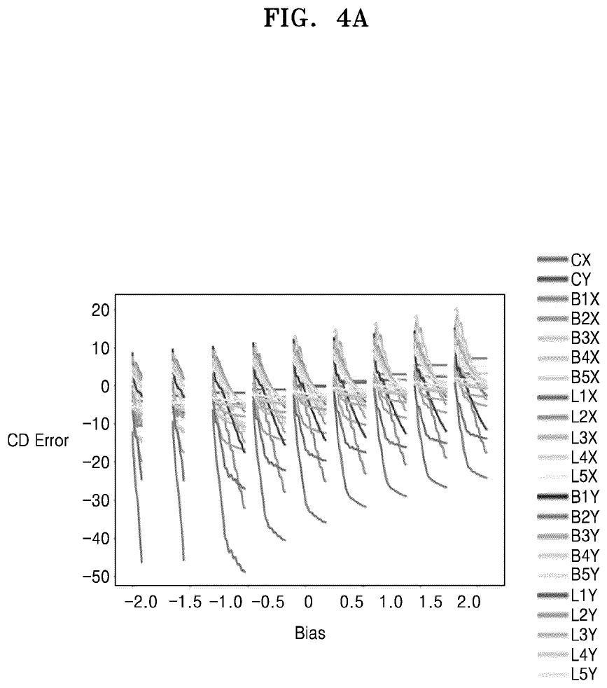

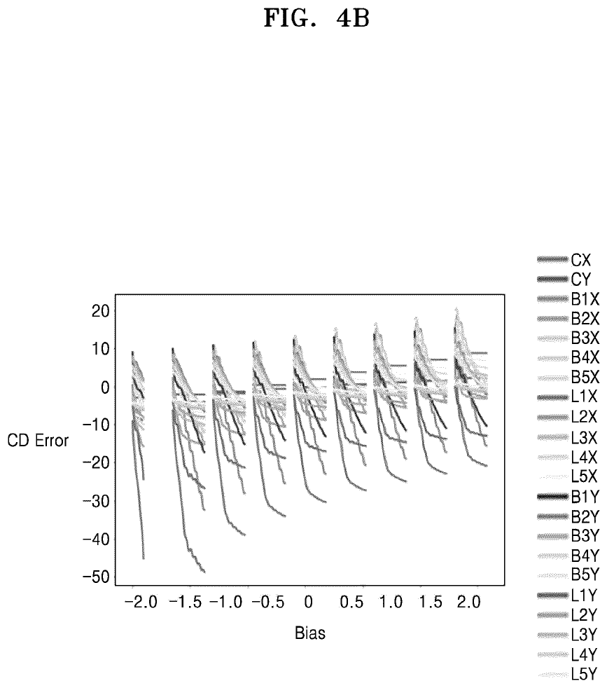

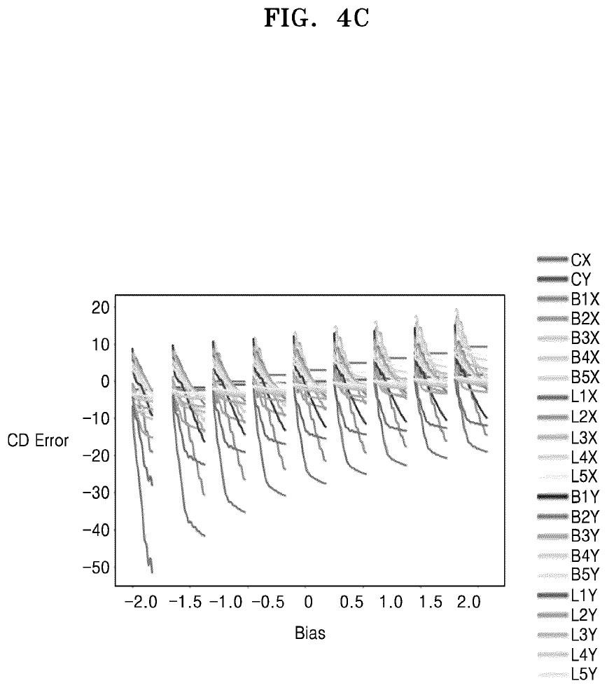

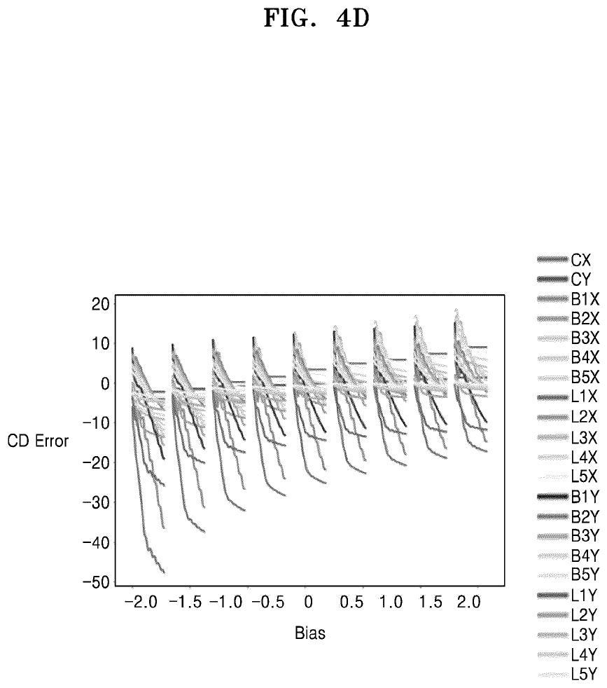

FIG. 3 is a flowchart showing in detail generating of individual kernel functions in the kernel function generating method of FIG. 1, and FIGS. 4A, 4B, 4C, and 4D are graphs showing calculated values of CD errors according to pitch, CNT bias, and BG bias, based on rigorous simulation. The details already described with reference to of FIGS. 1, 2A, 2B, 2C, 2D, and 2E are briefly described or omitted.

Referring to FIGS. 3, 4A, 4B, 4C, and 4D, in the generating of the individual kernel functions (S130), first, a linear or nonlinear relationship is searched for between the conditions of the factors and raw data of the CD error (S132). Here, the raw data may indicate, for example, CD errors calculated using rigorous simulation for the above 44352 datasets above.

FIGS. 4A, 4B, 4C, and 4D show CD errors calculated using rigorous simulation for the 44352 datasets above. Specifically, FIGS. 4A, 4B, 4C, and 4D show the results of calculating CD errors according to CNT bias and BG bias when the pitches are A, B, C, and D, respectively. In each of FIGS. 4A, 4B, 4C, and 4D, in order to identify trends according to CNT bias and BG bias, nine datasets of CD errors according to BG bias are arranged in the order of −2.0, −1.5, −1.0, −0.5, 0, 0.5, 1.0, 1.5, and 2.0 from the left according to CNT bias.

Additionally, CX, CY, BX, BY, LX, and LY are drawn in different colors in each dataset, and the saturation is displayed differently according to the outermost pattern number in a UBE. For reference, FIGS. 4A, 4B, 4C, and 4D are graphs in which color has been converted to grayscale, and only the difference in density between black and white is distinguished.

Referring to the overall graph, it may be seen that CD errors tend to increase as the CNT bias increases, and the tendency of each CD error according to the BG bias is similar to that of the CNT bias and pitch. However, as the environments of the bottom UBE and the left UBE are different, it may be confirmed that the tendency of CD error according to the BG bias of BX, BY and LX, LY is different. Based on the CD errors for the datasets of FIGS. 4A, 4B, 4C, and 4D, it is possible to perform a trend finding for a kernel function search according to pitch, CNT bias, and BG bias.

After finding a linear or nonlinear relationship, an initial kernel function for each factor is selected based on the linear or nonlinear relationship (S134). For example, in the case of pitch and CNT bias, as raw data for CD error has a linear relationship, a dot product kernel function may be selected as an initial kernel function, and in the case of BG bias, as raw data for CD error has a nonlinear relationship, a rational quadratic kernel function may be selected as an initial kernel function.

After selecting the initial kernel function, kernel parameters for the initial kernel function are derived through learning (S136). In other words, by learning the raw data of CD errors for factors by using the initial kernel function and deriving optimal values of kernel parameters, individual kernel functions for respective factors may be generated.

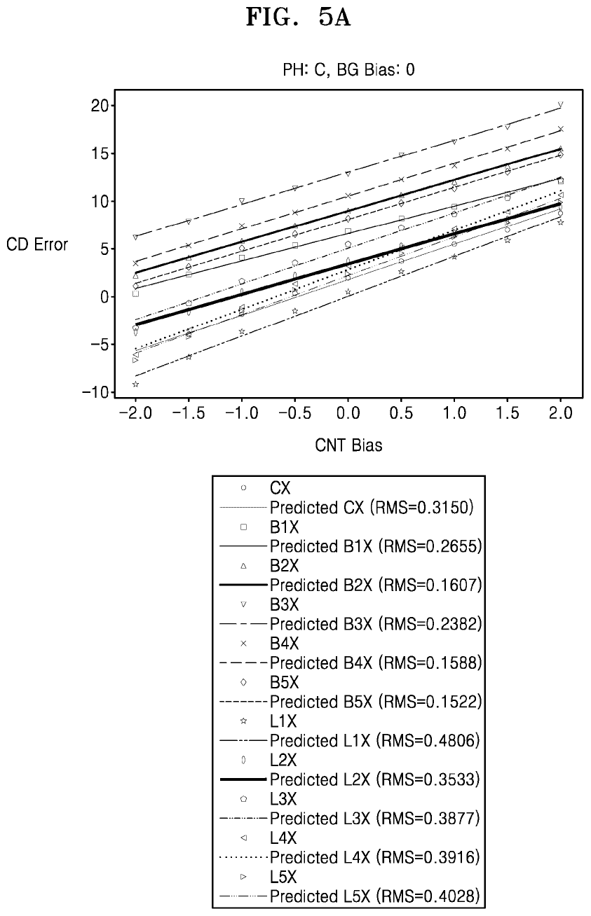

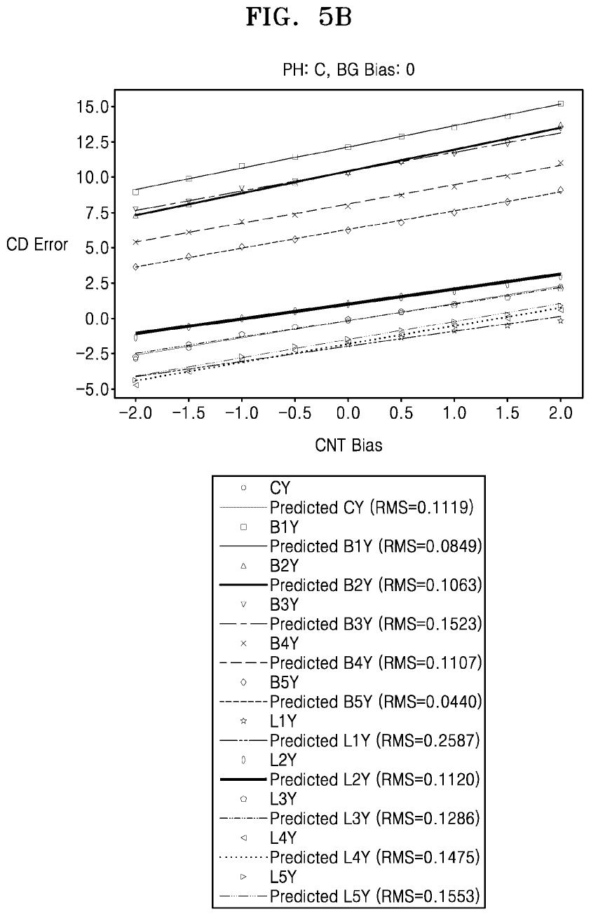

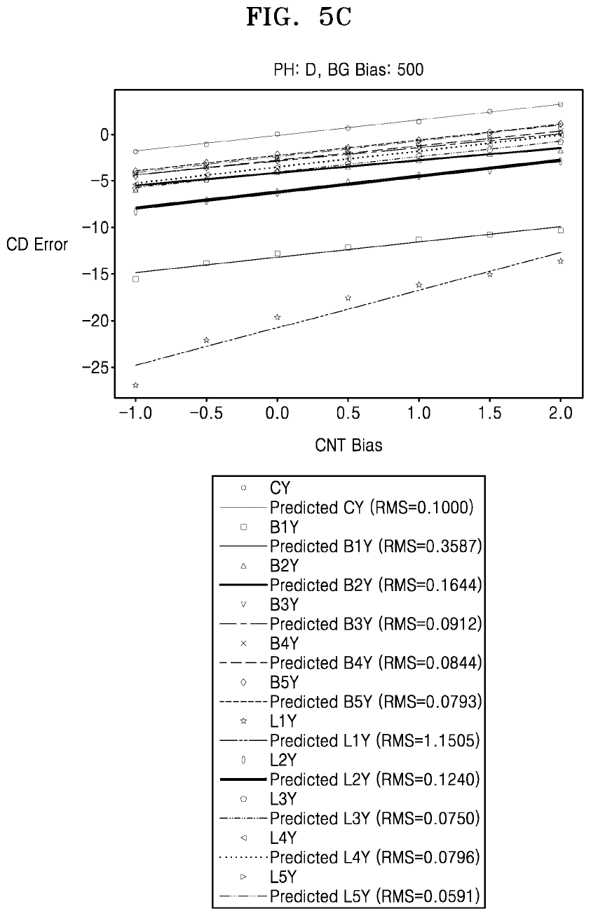

The selection of an initial kernel function and the derivation of kernel parameters for each of the initial kernel functions are described in detail in the description with reference to FIGS. 5A, 5B, 5C, 6A, 6B, 6C, 7A, 7B, and 7C below.

FIGS. 5A, 5B, and 5C are graphs showing prediction results of CD error according to CNT bias under fixed conditions of pitch and BG bias, based on a dot product kernel function.

Referring to FIGS. 5A, 5B, and 5C, dots in the graphs of FIGS. 5A to 5C represent raw data of CD error according to CNT bias under fixed conditions of pitch and BG bias. For example, in FIGS. 5A and 5B, a pitch may be C and a BG bias may be fixed to 0, and in FIG. 5C, a pitch may be D and a BG bias may be fixed to 500. Referring to the raw data of CD error, it may be seen that CD error and CNT bias show a linear relationship. Thus, in the kernel generation method of the present implementations, a dot product kernel function may be selected as the initial kernel function for the CNT bias. For example, the initial kernel function may be expressed as in Equation (1).

k(X, X′)=(BG_bi·BG_bi′+CNT_bi·CNT_bi′+PH·PH′)+σ₀ . . . Equation (1)

In Equation (1), k represents a kernel function, X is an input variable, and X′ is a value of X changed according to a condition. Additionally, BG_bi, CNT_bi, and PH represent BG bias, CNT bias, and pitch, respectively. Meanwhile, σ₀ is a kernel parameter of the dot product kernel function. To generate an optimal kernel function that simulates the impact of CD error due to CNT bias, the BG bias and the pitch may be fixed according to the CNT bias to proceed with optimization of the kernel parameters. Accordingly, as the conditions BG_bi=BG_bi′ and PH=PH′ in Equation (1) are satisfied, Equation (1) may be expressed as Equation (2).

k_{CNT_bi}(X, X′)=(BG_bi²+CNT_bi·CNT_bi′+PH²)+σ_{CNT_bi} . . . Equation (2)

By learning the raw data of CD error for CNT bias with the initial kernel function of Equation (2) and finding the optimal value of σ_{CNT_bi}, the individual kernel function of CD error for CNT bias may be obtained as in Equation (3). Here, learning may indicate ML as described above.

k_{CNT_bi}(X, X′)=(BG_bi²+CNT_bi·CNT_bi′+PH²)+0.000363 . . . Equation (3)

The CD error according to the CNT bias may be predicted under different conditions of pitch and BG bias through the individual kernel functions of Equation (3), and this is represented as a solid prediction line in the graphs of FIGS. 5A, 5B, and 5C. When calculating the RMS of the prediction line, it may be seen that the RMS of the prediction lines ranges from a minimum of 0.0440 nm to a maximum of 1.1505 nm. The maximum RMS is detected in the outermost pattern, L1Y, which shows that it is more difficult to accurately predict the CD error using the individual kernel functions towards the outermost pattern. As the maximum RMS is equal to or less than the first reference value of 1.5 nm, the kernel function of Equation (3) may be determined as an individual kernel function for the CNT bias.

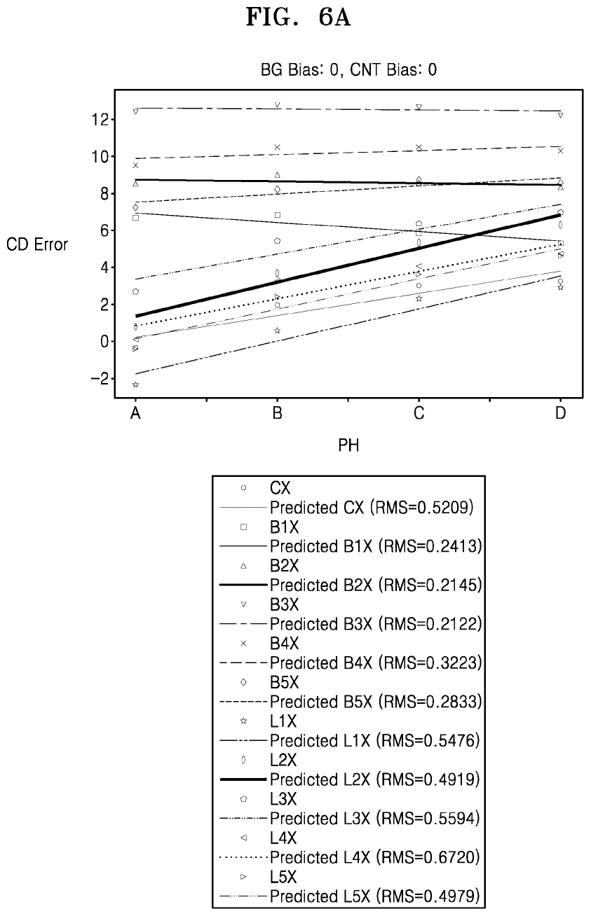

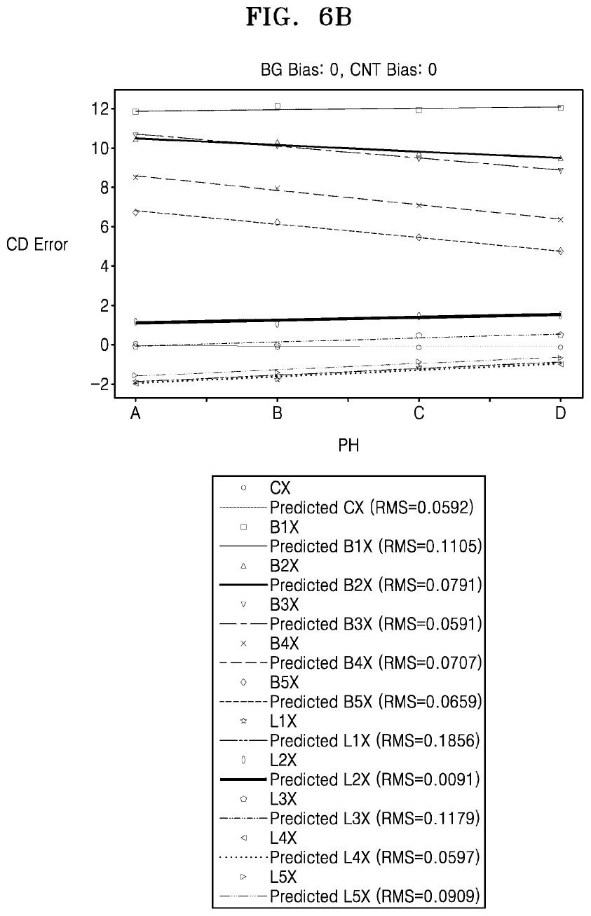

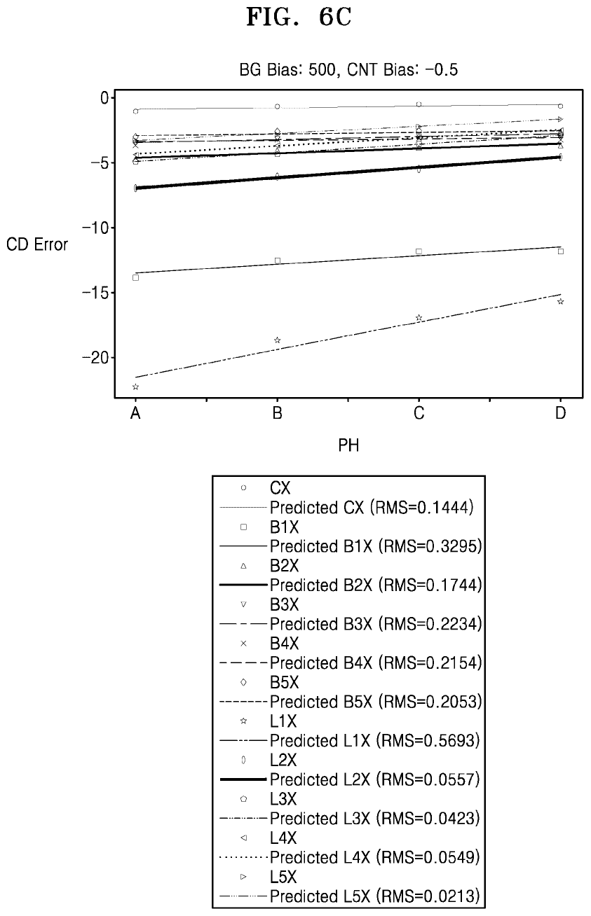

FIGS. 6A, 6B, and 6C are graphs showing prediction results of CD error according to pitch under fixed conditions of BG bias and CNT bias, based on a dot product kernel function.

Referring to FIGS. 6A, 6B, and 6C, in the graphs of FIGS. 6A, 6B, and 6C, points represent raw data of CD error according to pitch under fixed conditions of BG bias and CNT bias. For example, in FIGS. 6A and 6B, the BG bias and the CNT bias may be fixed to 0, and in FIG. 6C, the BC bias may be fixed to 500 and the CNT bias may be fixed to −0.5. Similar to the example for CNT bias, as the CD error and the pitch (PH) show a linear relationship, in the kernel generation method of the present implementations, for the pitch, the dot product kernel function is selected as the initial kernel function, and under the above fixed conditions, the pitch may be expressed as in Equation (4).

k_{PH}(X, X′)=(BG_bi²+CNT_bi²+PH·PH′)+σ_{PH} . . . Equation (4)

In the initial kernel function for pitch, as the BG bias and CNT bias are fixed, the BG bias and CNT bias may be determined as in Equation (4), and similarly, by learning the raw data of CD error for pitch with the initial kernel function of Equation (4) to obtain an optimal value of σ_{PH}, the individual kernel function of CD error for pitch may be obtained as in Equation (5).

k_{PH}(X, X′)=(BG_bi²+CNT_bi²+PH·PH′)+0.000363 . . . Equation (5)

As the pitch shows a linear relationship to CD error similar to CNT bias, it may be confirmed that the kernel parameters are optimized identically. The CD error according to the pitch is predicted under different conditions of BG bias and CNT bias through the individual kernel functions of Equation (5), and this is represented as a solid prediction line in the graphs of FIGS. 6A, 6B, and 6C. When calculating the RMS of the prediction line, it may be seen that the RMS of the prediction line ranges from a minimum of 0.0091 nm to a maximum of 0.6720 nm. Similarly, as the maximum RMS is less than or equal to the first reference value of 1.5 nm, the kernel function of Equation (5) may be determined as the individual kernel function for the pitch.

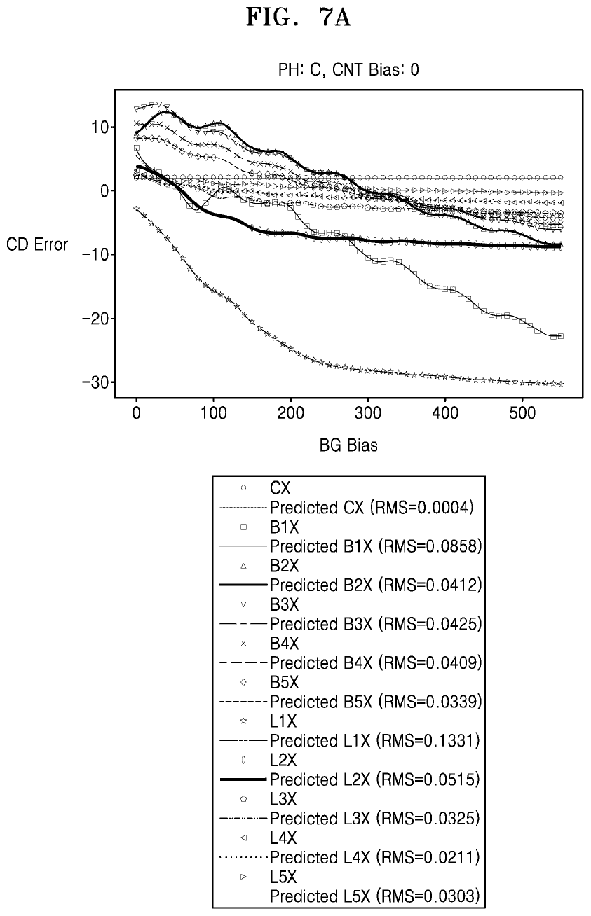

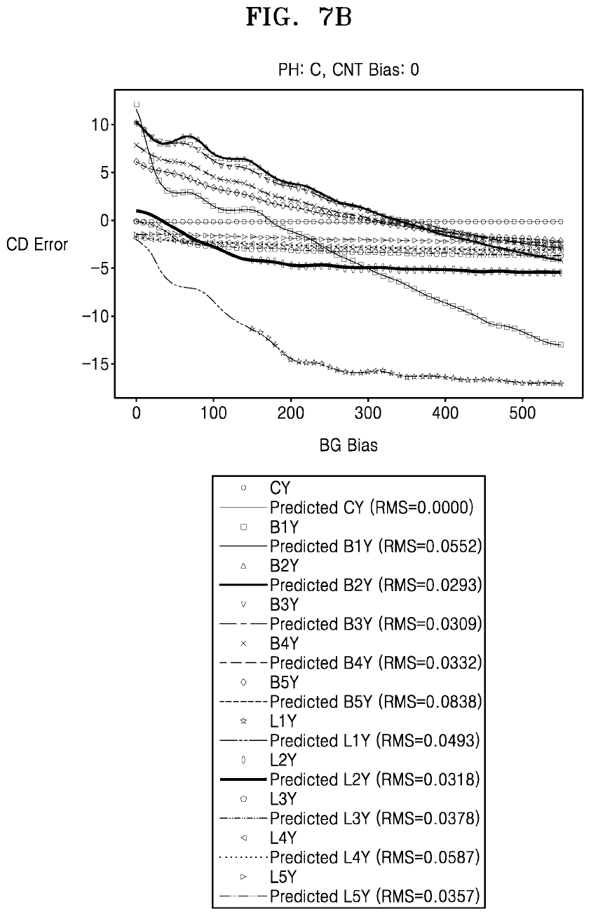

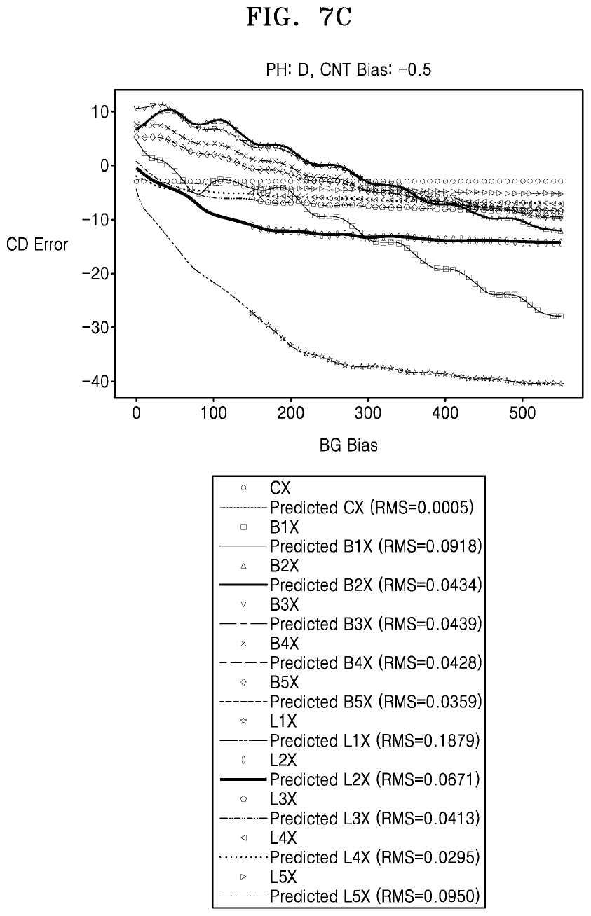

FIGS. 7A, 7B, and 7C are graphs showing prediction results of CD error according to BG bias under fixed conditions of pitch and CNT bias, based on a rational quadratic kernel function.

Referring to FIGS. 7A, 7B, and 7C, the dots in the graphs of FIGS. 7A, 7B, and 7C represent raw data of CD error according to BG bias under fixed conditions of pitch and CNT bias. For example, in FIGS. 7A and 7B, a pitch may be C and a CNT bias may be fixed to 0, and in FIG. 7C, a pitch may be D and a CNT bias may be fixed to −0.5. Unlike the CNT bias or pitch, the CD error and BG bias have a nonlinear relationship and are data with a relatively large scale difference and a noisy wave-shape. Thus, in the kernel generation method of the present implementations, a rational quadratic kernel function may be selected as the initial kernel function for the BG bias. For example, the initial kernel function may be expressed as in Equation (6).

k(X, X′)=[1+{(BG_bi−BG_bi′)²+(CNT_bi−CNT_bi′)²+(PH-PH′)²}/(2α·l²)]^{-α} . . . Equation (6)

In Equation (6), α and l are kernel parameters of the rational quadratic kernel function. To generate an optimal kernel function that simulates the impact of CD error due to BG bias, the CNT bias and pitch are fixed according to the BG bias, and accordingly, optimization of kernel parameters may be performed. Accordingly, as the conditions CNT_bi=CNT_bi′ and PH=PH′ in Equation (6) are satisfied, Equation (6) may be expressed in Equation (7).

k_{BG_bi}(X, X′)={1+(BG_bi−BG_bi′)²/(2α_{BG_bi}·l_{BG_bi}²)}^{-αBG_bi} . . . Equation (7)

By learning the raw data of CD error for BG bias with the initial kernel function of Equation (7) and obtaining optimal values of α_{BG_bi} and l_{BG_bi}, α_{BG_bi}=1.0021 and l_{BG_bi}=1.0395 may be derived. Accordingly, the individual kernel function of CD error for BG bias may be obtained by Equation (8).

k_{BG_bi}(X, X′)={1+(BG_bi−BG_bi′)²/2.1657}^{-1.0021} . . . Equation (8)

The CD error according to the BG bias is predicted under different conditions of pitch and CNT bias through the individual kernel function of Equation (8), and this is represented as a prediction line in the graphs of FIGS. 7A, 7B, and 7C. When calculating the RMS of the prediction line, it may be seen that the RMS of the prediction line ranges from a minimum of 0 nm to a maximum of 0.1879 nm. As CD errors at the center, CX and CY, do not change with the BG bias, the CD errors show prediction accuracy close to 0. Similarly, it may be seen that the prediction accuracy decreases to some extent toward the outermost pattern. It may be seen that by optimizing a nonlinear kernel function, it is possible to make relatively accurate predictions even for large CD errors under various conditions. However, it may be confirmed that errors still exist when using the individual kernel functions. Similarly, as the maximum RMS is equal to or less than the first reference value of 1.5 nm, the kernel function of Equation (8) may be determined as an individual kernel function for the BG bias.

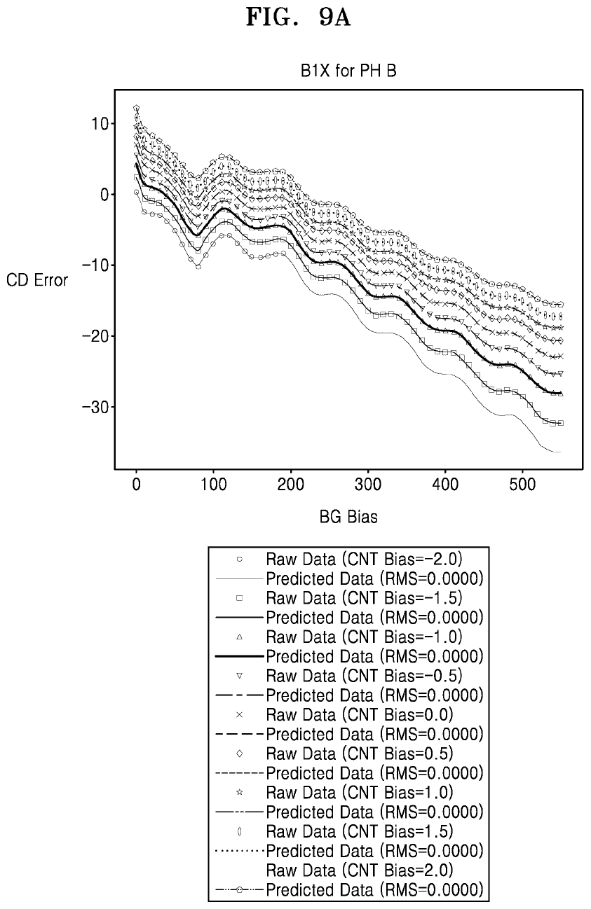

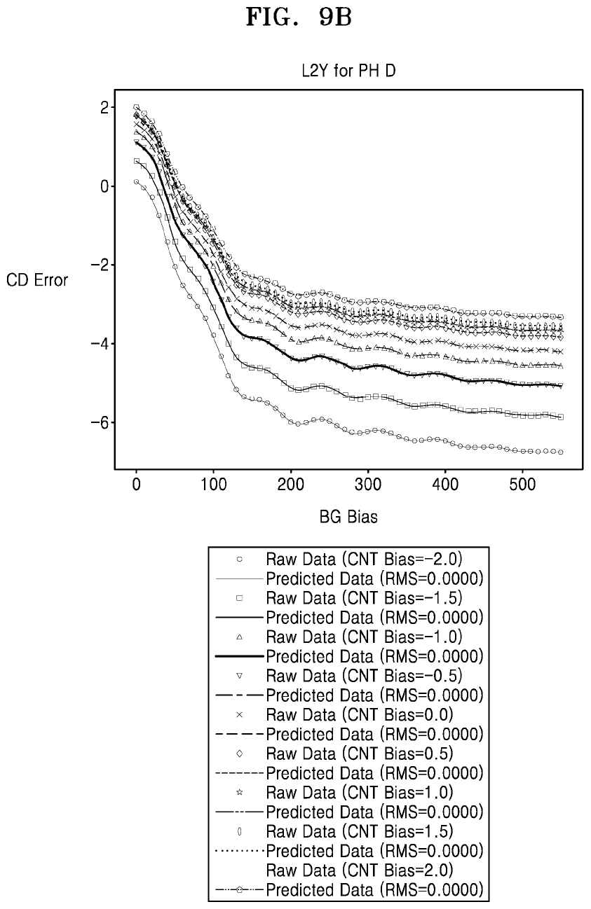

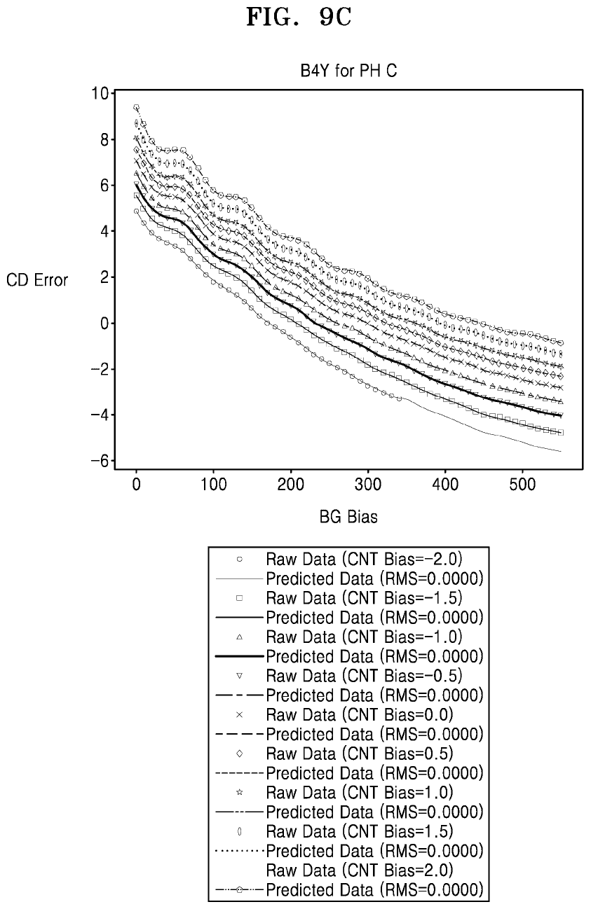

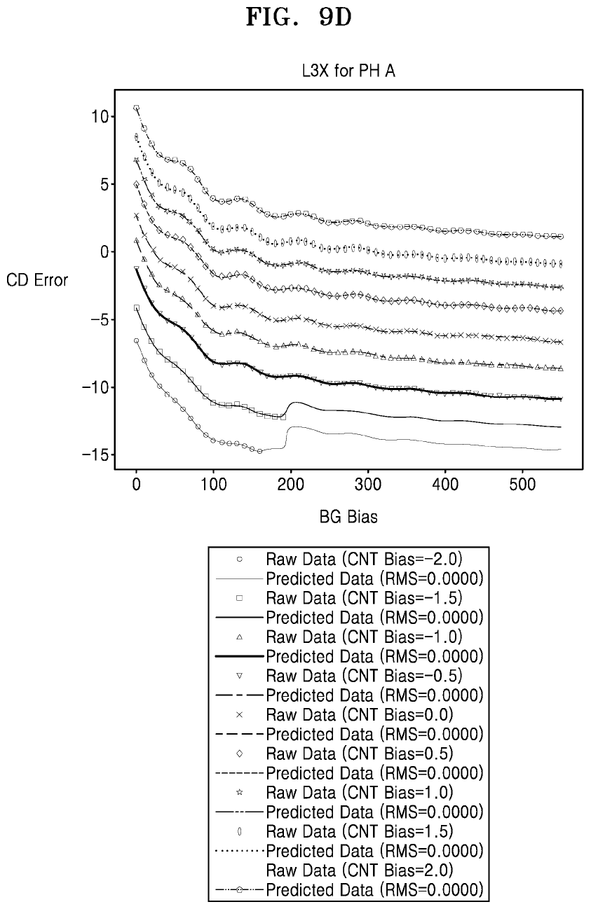

FIGS. 8A and 8B are graphs conceptually illustrating a method of generating a combined kernel function, and FIGS. 9A, 9B, 9C, and 9D are graphs showing prediction results of CD errors according to pitch, CNT bias, and BG bias, based on the combined kernel function.

Referring to FIGS. 8A, 8B, 9A, 9B, 9C, and 9D, through the process described previously with reference to FIGS. 5A, 5B, 5C, 6A, 6B, 6C, 7A, 7B, and 7C, the individual kernel functions k_{CNT_bi}(X, X′), k_{PH}(X, X′), and k_{BG_bi}(X, X′) according to the CNT bias, pitch, and BG bias may be determined using Equations (3), (5), and (8). Subsequently, in order to obtain a final kernel function that considers the impact of all three factors, in the kernel generation method of the present implementations, a combined kernel function may be defined through a dot product and expressed as Equation (9).

k_{combined}(X, X)=p[(BG_bi²+CNT_bi²+PH·PH′)+0.000363]·q[{1+(BG_bi−BG_bi′)²/2.1657}^{-1.0021}]·r[BG_bi²+CNT_bi²+PH·PH′)+0.000363] . . . Equation (9)

In Equation (9), p, q, and r are weights. For example, relatively high weights may be assigned to individual kernel functions related to factors that have a relatively large impact on the CD error, and relatively low weights may be assigned to individual kernel functions related to factors that have a relatively small impact on the CD error.

In FIG. 8A, from left to right, the graphs are for the CD error predicted using the individual kernel functions for CNT bias, pitch (PH), and BG bias, and X between the graphs indicates that all the individual kernel functions are multiplied, i.e., a dot product is formed. Additionally, FIG. 8B shows the CD error according to BG bias predicted using a combined kernel function obtained by taking a dot product of all individual kernel functions. For reference, the respective graphs in FIG. 8A may correspond to the graphs in FIGS. 5B, 6B, and 7B, and FIG. 8B may correspond to the graph in FIG. 9A. That is, the graphs in FIGS. 8A and 8B are examples of graphs introduced to conceptually describe the principle of generating a combined kernel function.

FIGS. 9A, 9B, 9C, and 9D show the accuracy of prediction of CD error under different conditions of pitch, CNT bias, and BG bias, based on the combined kernel function of Equation (9). Specifically, FIGS. 9A, 9B, 9C, and 9D respectively show the raw data of the CD error (dots) and the predicted data by the combined kernel function (prediction line) according to the BG bias under different CNT bias conditions for B1X at pitch B, for L2Y at pitch D, for B4Y at pitch C, and for L3X at pitch A, respectively. When calculating the RMSs of the prediction lines of FIGS. 9A, 9B, 9C, and 9D, it may be confirmed that the RMSs are all 0.0000, and it may be seen that the prediction accuracy of the combined kernel function is 100% up to the fourth decimal place.

This is a result showing that, by analyzing the impact of pitch, CNT bias, and BG bias, which have a relatively great impact on the CD error of a cell pattern, defining individual kernel functions for respective factors, and generating a combined kernel function a dot product of these individual kernel functions, according to the kernel function generation method of the present implementations, an optimal kernel function that may accurately predict CD errors for various cell patterns may be generated.

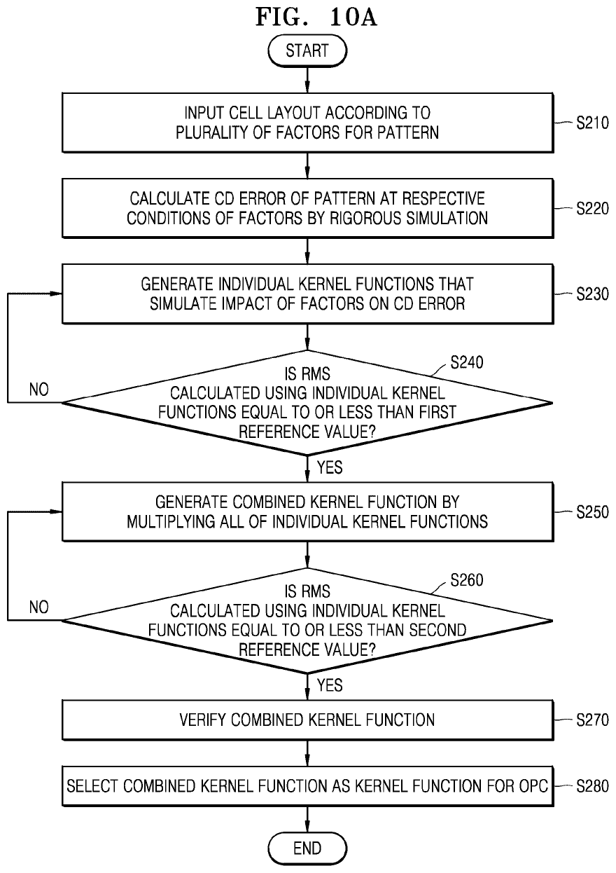

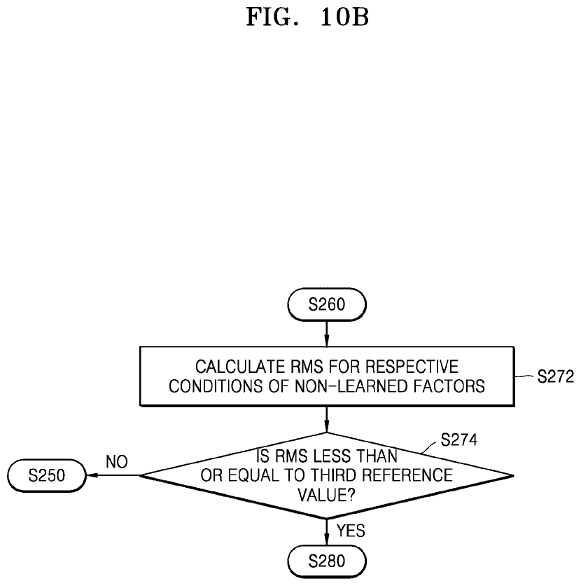

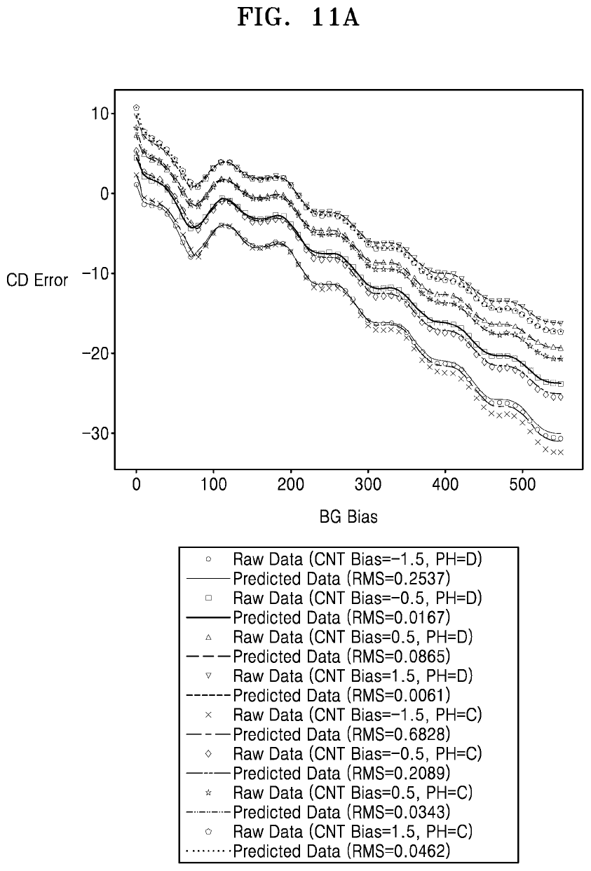

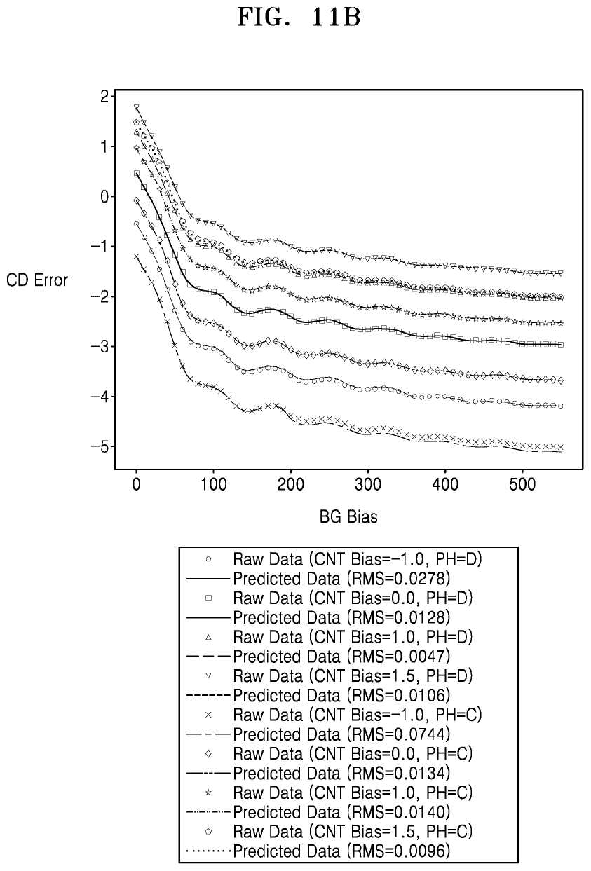

FIG. 10A is a flowchart schematically showing a process of a kernel function generation method according to some implementations, and FIG. 10B is a flowchart showing in detail generating of a combined kernel function in the kernel function generation method of FIG. 10A. FIGS. 11A and 11B are graphs showing prediction results of CD error in a UBE according to BG bias under non-learned conditions of a pitch and a CNT bias.

Referring to FIGS. 10A, 10B, 11A, and 11B, in the kernel function generation method of the present implementations, a combined kernel function is generated by performing operations from inputting a cell layout (S210) to determining whether the RMS is less than or equal to a second reference value (S260). The operations from the inputting of a cell layout (S210) to the determining whether the RMS is less than or equal to the second reference value (S260) are the same as those described in regard to the inputting of a cell layout (S110) to the determining whether the RMS is less than or equal to the second reference value (S160) in the kernel function generation method of FIG. 1.

Next, the combined kernel function is verified (S270). In operation S270 of verifying the combined kernel function, first, the predicted degree of CD error is calculated using an RMS for respective conditions of non-learned factors, as illustrated in FIG. 10B (S272). Specifically, the entire dataset is split into training data and validation data, and then the training data is trained using the combined kernel function of Equation (9), and then how well the validation data is predicted is checked. That is, an RMS between a CD error predicted by the combined kernel function and a CD error of the validation data is calculated.

Next, whether the RMS is less than or equal to a third reference value is determined (S274). The third reference value may be, for example, 1.0 nm, which is the same as the second reference value. However, the third reference value is not limited to the above value. If the RMS value exceeds the third reference value, the process proceeds to the generating of a combined kernel function (S250), and the weights of the individual kernel functions are changed to generate a combined kernel function again. If RMS is less than or equal to the third reference value (Yes), the combined kernel function is selected as the kernel function for OPC (S280).

FIGS. 11A and 11B show the accuracy of prediction of CD error in a UBE according to BG bias under different non-learned conditions of a pitch and a CNT bias. Specifically, FIG. 11A shows the CD error according to BG bias under the conditions of CNT bias −1.5, −0.5, 0.5, and 1.5 for B1X at pitch C and pitch D, and FIG. 11B shows the CD error according to BG bias under the conditions of CNT bias −1.0, 0.0, 1.0, and 1.5 for L3Y at pitch C and pitch D. The RMS calculated for the verification data ranges from a minimum of 0.0047 nm in FIG. 11B to a maximum of 0.6828 nm in FIG. 11A, and as the maximum RMS is less than the third reference value of 1.0 nm, it may be confirmed that the verification data is sufficiently predictable. In addition, as a numerical value of the UBE environment changes within the chip of an actual DRAM product, it may be confirmed that the RMS is calculated to be equal to or less than 0.05 nm at a level where the BG bias is up to 150 nm, allowing for accurate prediction of the CD error.

FIG. 12 is a flowchart schematically showing a process of an OPC method by using a kernel function, according to some implementations. The details already described with reference to FIGS. 1, 2A, 2B, 2C, 2D, 2E, 3, 4A, 4B, 4C, 4D, 5A, 5B, 5C, 6A, 6B, 6C, 7A, 7B, 8A, 8B, 9A, 9B, 9C, 9D, 10A, 10B, 11A, and 11B are briefly described or omitted.

Referring to FIG. 12, in the OPC method using a kernel function of the present implementations (hereinafter, simply referred to as the ‘OPC method’), operations from inputting of a cell layout (S310) to selecting of a combined kernel function as a kernel function for OPC (S370) are sequentially performed. The operations from inputting of a cell layout (S310) to selecting of a combined kernel function as a kernel function for OPC (S370) are the same as the inputting of a cell layout (S110) to selecting of a combined kernel function as a kernel function for OPC (S170) in the kernel function generation method of FIG. 1.

Next, an OPC model is generated using the combined kernel function (S380). The OPC model may refer to a model used to perform simulations in the OPC method. To briefly describe the OPC method, the OPC method refers to a method of suppressing the occurrence of the optical proximity effect (OPE) by correcting a layout of a pattern to overcome the OPE that occurs during an exposure process due to the impact between neighboring patterns as the pattern becomes finer.

The OPC method is broadly divided into two types: a rule-based OPC method and a simulation-based or model-based OPC method. The model-based OPC method may be advantageous in terms of time and cost because only measurement results of representative patterns are used without having to measure all of a large number of test patterns.

The OPC method may include not only modification of the layout of a pattern, but also a method of adding sub-lithographic features called serifs on the corners of the pattern, or a method of adding sub-resolution assist features (SRAFs) such as scattering bars.

To perform the OPC method, first, basic data for OPC is prepared. Here, the basic data may include data on the shape of the patterns of a sample, the location of the patterns, the type of measurement such as a measurement on the space or line of the pattern, and the basic measurement value. Additionally, the basic data may include information such as a thickness, a refractive index, and a dielectric constant for a photoresist (PR), and a source map for the type of illumination system. The basic data is not limited to the data described above.

After preparing the basic data, an optical OPC model is generated. Generation of an optical OPC model may include optimization of a defocus stand (DS) position, a best focus (BF) position, etc. during an exposure process. Additionally, the generation of an optical OPC model may include generation of an optical image that considers the diffraction phenomenon of light or the optical state of an exposure equipment itself. The generation of an optical OPC model is not limited to the above. For example, the generation of an optical OPC model may include various factors related to optical phenomena in the exposure process.

After generating the optical OPC model, an OPC model for the PR is generated. Generation of an OPC model for a PR may include optimization of a threshold value of the PR. Here, the threshold value of a PR indicates a threshold value at which a chemical change occurs in the exposure process, and for example, the threshold value may be given by the intensity of exposure light. Generation of an OPC model for a PR may also include selecting an appropriate model form from several PR model forms.

The optical OPC model and the OPC model for PR are combined and are generally referred to as an OPC model. After generating an OPC model, an OPC-ed layout may be generated by performing a simulation using the OPC model. A kernel function is a function that expresses a transfer process considering OPE and may be used to generate an optical OPC model.

After generating the OPC model, a simulation is performed using the OPC model (S390). By performing a simulation, a mask contour of a target pattern may be extracted. Additionally, an Edge Placement Error (EPE) between the target pattern and the mask contour may be calculated. Afterwards, the simulation is repeated while changing the factors within the OPC model until the EPE reaches a set reference value. Ultimately, the objective of the OPC method may be to make the mask contour as similar as possible to the shape of the target mask.

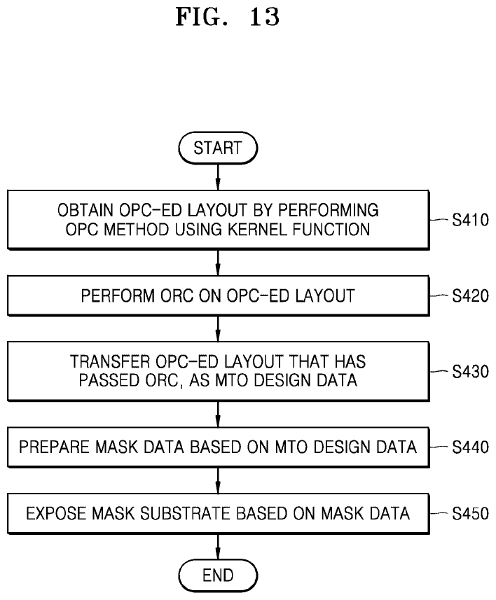

FIG. 13 is a flowchart schematically showing a process of a mask manufacturing method including an OPC method, according to some implementations. The details already described with reference to FIGS. 1, 2A, 2B, 2C, 2D, 2E, 3, 4A, 4B, 4C, 4D, 5A, 5B, 5C, 6A, 6B, 6C, 7A, 7B, 7C, 8A, 8B, 9A, 9B, 9C, 9D, 10A, 10B, 11A, 11B, and 12 are briefly described or omitted.

Referring to FIG. 13, in the mask manufacturing method including the OPC method of the present implementations (hereinafter, simply referred to as a ‘mask manufacturing method’), an OPC-ed layout is obtained by performing an OPC method using a kernel function (S410). The OPC method using the kernel function is as described with reference to FIG. 12. The OPC-ed layout may correspond to a mask layout with a minimized EPE obtained using the OPC method using a kernel function.

After generating the OPC-ed layout, optical rule check (ORC) is performed on the OPC-ed layout (S420). ORC may include, for example, an RMS calculation for CD error, an EPE calculation, a pinch error inspection, a bridge error inspection, etc. However, the items tested in ORC are not limited to those described above.

When performing ORC, it is determined whether a defect exists, where a defect may correspond to cases where the RMS for CD error is greater than a set reference value, EPE is greater than a set reference value, a pinch error exists, a bridge error exists, etc. Additionally, if there are other items in the ORC, cases where those items deviate from a reference may correspond to a defect.

When performing ORC, if a defect exists, depending on the cause, the process proceeds to operation S410 of obtaining an OPC-ed layout. Thus, before moving to the obtaining of an OPC-ed layout (S410), analyzing the cause of the defect and reflecting the cause in an OPC model corresponding thereto may be performed first.

When performing ORC, if no defect exists, the OPC-ed layout is determined as a final OPC-ed layout, and a final OPC-ed layout image is transferred to a mask production team as mask tape-out (MTO) design data (S430). In general, MTO may indicate handing over final mask data obtained via the OPC method to the mask manufacturing team and requesting mask manufacturing. Thus, the MTO design data may ultimately be substantially identical to the data for the final OPC-ed layout image obtained via the OPC method. The MTO design data may have a graphic data format used in electronic design automation (EDA) software, etc. For example, the MTO design data may have data formats such as Graphic Data System II (GDS2) and Open Artwork System Interchange Standard (OASIS).

Afterwards, mask data preparation (MDP) is performed (S440). MDP may include i) format conversion, called, for example, fracturing, ii) augmentation of barcodes for machine reading, standard mask patterns for inspection, job decks, etc., and iii) verification, both automatic and manual. Here, job deck may indicate generating a text file containing a series of instructions for the placement information of multiple mask files, reference dose, exposure speed or method, etc.

Format conversion, or fracturing, may refer to the process of splitting MTO design data into each region and changing the same into a format for electron beam exposure. The fracturing may include data manipulations such as scaling, sizing, rotating data, reflecting patterns, inverting colors, etc. During a transformation process through fracturing, data may be corrected for numerous systematic errors that may occur somewhere during a transfer process from design data to an image on a wafer. The data correction process for the above systematic errors is called Mask Process Correction (MPC), and may include tasks such as line width adjustment called CD adjustment and improving pattern placement precision. Thus, fracturing may contribute to improving the quality of a final mask and may also be a process performed in advance for MPC. Here, systematic errors may be caused by distortions occurring in an exposure process, mask development and etching process, and wafer imaging process.

The MDP may include MPC. As described above, MPC is a process of correcting systematic errors, that is, errors that occur during an exposure process. Here, the exposure process may be a concept that comprehensively includes electron beam writing, development, etching, baking, etc. Additionally, data processing may be performed prior to the exposure process. Data processing is a kind of preprocessing process for mask data, and may include grammar checking for the mask data, exposure time prediction, etc.

After MDP, a mask substrate is exposed based on the mask data (S450). Here, exposure may indicate, for example, electron beam writing. Here, the electron beam writing may be performed using, for example, a grayscale writing method using a multi-beam mask writer (MBMW). Additionally, the electron beam writing may also be performed using a variable shape beam (VSB) exposure device.

After the MDP, a process of converting the mask data into pixel data may be performed before the exposure process. Pixel data is data directly used for actual exposure, and may include data about the shape to be exposed and data about the dose assigned to each shape. Here, the shape data may be bit-map data obtained by converting vector data into shape data through rasterization or the like.

After the exposure process, a series of processes are performed to complete a mask. The series of processes may include, for example, developing, etching, and cleaning. Additionally, a series of processes for mask manufacturing may include metrology processes, defect inspection, or defect repair processes. Additionally, a pellicle application process may be included. Here, the pellicle application process may refer to a process of attaching a pellicle to a mask surface to protect the mask from subsequent contamination during delivery and the mask's usable lifespan, once it is confirmed, through final washing and inspection, that there are no contaminants or chemical stains.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand alone program, e.g., as an app, or as a software module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or microcontrollers or a combination of them, or any other kind of central processing unit. Generally, a central processing unit will receive instructions and data from a read only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., on a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While this disclosure has been particularly shown and described with reference to implementations thereof, it will be understood that various changes in form and details may be made therein without departing from the spirit and scope of the following claims.

What is claimed is:

1. A method of generating a kernel function, the method comprising:
providing data of a cell layout according to a plurality of factors for a pattern;
calculating, by one or more processors, a respective critical dimension (CD) error of the pattern for each factor of the plurality of factors under varying conditions of remaining factors of the plurality of factors;
generating, by the one or more processors, and for each CD error, individual kernel functions that simulate an impact of each factor of the plurality of factors on the CD error;
generating, by the one or more processors, a combined kernel function by multiplying the individual kernel functions;
performing an optical proximity correction on the cell layout data using the combined kernel function; and
exposing a mask substrate based on the optical proximity corrected cell layout data.

2. The method of claim 1, wherein the plurality of factors comprise a pitch of the pattern, a first bias for a size of the pattern, and a second bias for a distance between the pattern and a block edge,
wherein each of the pitch, the first bias, and the second bias is split into a plurality of conditions.

3. The method of claim 2, wherein generating the individual kernel functions comprises, for each factor of the plurality of factors:
finding a linear relationship or a nonlinear relationship between the conditions of the factor and raw data of the CD error for the factor;
selecting an initial kernel function of the factor based on the linear relationship or the nonlinear relationship; and
deriving kernel parameters for the initial kernel function, through machine learning.

4. The method of claim 3, wherein, selecting the initial kernel function comprises:
for each of the pitch and the first bias, selecting a dot product kernel function based on the linear relationship; or
for the second bias, selecting a rational quadratic kernel function based on the nonlinear relationship.

5. The method of claim 1, wherein calculating the CD error comprises performing a simulation.

6. The method of claim 1, wherein
generating the individual kernel functions is based on a root mean square (RMS) of a difference between a first CD error predicted using the individual kernel functions and a second CD error calculated by a simulation exceeding a first reference value, and
after the generating of the individual kernel functions, determining the individual kernel functions is based on the RMS being less than or equal to the first reference value.

7. The method of claim 1, wherein, generating the combined kernel function comprises applying weights to the individual kernel functions, and
the method comprises
generating the combined kernel function by changing the weights based on a root mean square (RMS) of a difference between a first CD error obtained using the combined kernel function and a second CD error calculated by a simulation exceeding a second reference value, and
after the generating of the combined kernel function, determining that the RMS is less than or equal to the second reference value.

8. The method of claim 1, comprising verifying, after generating the combined kernel function, the combined kernel function.

9. The method of claim 8, wherein, verifying the combined kernel function comprises generating the individual kernel functions based on data that was not used for generating the individual kernel functions.

10. An optical proximity correction (OPC) method comprising:
providing data of a cell layout according to a plurality of factors for a pattern;
calculating, by one or more processors, a respective critical dimension (CD) error of the pattern for each factor of the plurality of factors under varying conditions of remaining factors of the plurality of factors;
generating, by the one or more processors, and for each CD error, individual kernel functions that simulate an impact of each factor of the plurality of factors on the CD error;
generating, by the one or more processors, a combined kernel function by applying weights to the individual kernel functions and multiplying the individual kernel functions;
generating, by the one or more processors, an OPC model by using the combined kernel function;
performing, by the one or more processors, a simulation by using the OPC model; and
exposing a mask substrate based on a result of the simulation.

11. The OPC method of claim 10, wherein the plurality of factors comprise a pitch of the pattern, a first bias for a size of the pattern, and a second bias for a distance between the pattern and a block edge, and wherein each of
the pitch, the first bias, and the second bias is split into a plurality of conditions.

12. The OPC method of claim 11, wherein generating the individual kernel functions comprises, for each factor of the plurality of factors:
finding a linear relationship or a nonlinear relationship between the conditions of the factor and raw data of the CD error;
selecting an initial kernel function for the factor based on the linear relationship or the nonlinear relationship; and
deriving kernel parameters for the initial kernel function, through machine learning.

13. The OPC method of claim 10, comprising,
based on a root mean square (RMS) of a difference between a first CD error obtained using the individual kernel functions and a second CD error calculated by a simulation exceeding a first reference value, generating the individual kernel functions, and
after generating the individual kernel functions, determining that the RMS is less than or equal to the first reference value.

14. The OPC method of claim 10, comprising,
based on a root mean square (RMS) of a difference between a first CD error obtained using the combined kernel function and a second CD error calculated by a simulation exceeding a second reference value, generating the combined kernel function by changing weights of the individual kernel functions, and
determining, after the generating of the combined kernel function, that the RMS is less than or equal to a second reference value.

15. The OPC method of claim 10, comprising verifying, after generating the combined kernel function, the combined kernel function.

16. A method of manufacturing a mask, the method comprising:
obtaining an optical proximity corrected (OPC-ed) layout by performing an optical proximity correction (OPC) method using a kernel function;
performing an optical rule check (ORC) on the OPC-ed layout;
transferring a final OPC-ed layout that has passed the ORC, as mask tape-out (MTO) design data;
preparing mask data based on the MTO design data; and
exposing a mask substrate based on the mask data,
wherein obtaining the OPC-ed layout comprises
providing data of a cell layout according to a plurality of factors for a pattern,
calculating, by one or more processors, a respective critical dimension (CD) error of the pattern for each factor of the plurality of factors under varying conditions of remaining factors of the plurality of factors,
generating, by the one or more processors, and for each CD error, individual kernel functions that simulate an impact of each factor of the plurality of factors on the CD error,
generating, by the one or more processors, a combined kernel function by applying weights to the individual kernel functions and multiplying the individual kernel functions,
generating, by the one or more processors, an OPC model by using the combined kernel function, and
performing, by the one or more processors, a simulation by using the OPC model.

17. The method of claim 16, wherein the plurality of factors comprise a pitch of the pattern, a first bias for a size of the pattern, and a second bias for a distance between the pattern and a block edge, and
wherein each of the pitch, the first bias, and the second bias is split into a plurality of conditions.

18. The method of claim 17, wherein generating the individual kernel functions comprises, for each factor of the plurality of factors:
finding a linear relationship or a nonlinear relationship between the conditions of the factor and raw data of the CD error;
selecting an initial kernel function of the factor based on the linear relationship or the nonlinear relationship; and
deriving kernel parameters for the initial kernel function, through machine learning.

19. The method of claim 16, comprising, after generating the individual kernel functions, determining that a root mean square (RMS) of a difference between a first CD error obtained using the individual kernel functions and a second CD error calculated by a simulation is less than or equal to a first reference value, and
after the generating of the combined kernel function, determining that an RMS of a difference between a third CD error obtained using the combined kernel function and the second CD error calculated by the simulation is less than or equal to a second reference value.

20. The method of claim 16, comprising verifying, after generating the combined kernel function, the combined kernel function.
